(19) United States
(12) Patent Application Publication
(10) Pub. No.: US 2023/0046737 A1
(43) Pub. Date: Feb. 16, 2023

(54) CURABLE SILICONE COMPOSITION AND CURED PRODUCT THEREOF

(71) Applicant: DOW SILICONES CORPORATION, Midland, MI (US)

(72) Inventor: Jina CHON, Chungcheongbuk-do (KR)

(21) Appl. No.: 17/786,567

(22) PCT Filed: Dec. 17, 2020
(86) PCT No.: PCT/US2020/065712

§ 371 Date: Jun. 17, 2022

Related U.S. Application Data
(60) Provisional application No. 62/950,081, filed on Dec. 18, 2019.

(51) Int. Cl. C08L 83/06

(52) U.S. Cl. CPC C08L 83/06; C08L 2205/025

(57) ABSTRACT

A curable silicone composition is provided. The composition comprises: (A) an epoxy-functional silicone resin having monovalent aromatic hydrocarbon groups; (B) an epoxy-functional silicone having monovalent aromatic hydrocarbon groups; and (C) a cationic photoinitiator. Optionally, the composition further comprises (D) an epoxy-functional silicone free of monovalent aromatic hydrocarbon groups. The composition has excellent curability with UV radiation, and further with heating, generally forms a cured product with excellent transparency and mechanical properties.

### CROSS-REFERENCE TO RELATED APPLICATIONS

This application claims priority to and all advantages of U.S. Provisional Patent Application No. 62/950,081 filed on 18 Dec. 2019, the content of which is incorporated herein by reference.

### FIELD OF THE INVENTION

The present invention relates to a curable silicone composition and a cured product thereof.

### DESCRIPTION OF THE RELATED ART

Epoxy-functional silicones are used for curable silicone compositions which can be cured by irradiation with ultraviolet (“UV”) ray. For example, Patent Document 1 discloses a curable silicone composition comprising: an epoxy-functional silicone resin represented by the average unit formula: (R₃SiO_{1/2})ᵢ(R₂SiO_{2/2})ᵢᵢ(RSiO_{3/2})ᵢᵢᵢ(SiO_{4/2})ᵢᵥ, wherein each R is an organic group is independently selected from C₁₋₆ monovalent aliphatic hydrocarbon group, C₆₋₁₀ monovalent aromatic hydrocarbon group, and a monovalent epoxy-substituted organic group; 0≤i<0.4, 0<ii<0.5, 0<iii<1, 0≤iv<0.4, 0.1≤ii/iii≤0.3, i+ii+iii+iv=1, the resin has a number-average molecular weight of at least about 2,000, at least about 15 mol % of the organic groups are C₆₋₁₀ monovalent aromatic hydrocarbon groups, and about 2 to about 50 mol % of siloxane units have epoxy-substituted organic groups; an epoxy-functional silicone oligomer represented by the general formula: R″R′₂SiO(R′₂SiO)ᵥSiR′₂R″, wherein each R′ is C₁₋₈ alkyl group, each R″ is an epoxy-substituted organic group, “v” is 0 or a positive integer; and a cationic photoinitiator, wherein the composition can be cured by irradiation with UV ray.

However, such a curable silicone composition has a problem that the composition is not sufficiently cured, or a cured product has poor transparency and mechanical properties.

Therefore, it is desired to develop a curable silicone composition with excellent curability with UV radiation, and further with heating, to form a cured product with good transparency and mechanical properties.

### [CITATION LIST]: PATENT LITERATURE

Patent Document 1: United States Patent Application Publication No. 2014/154626 A1

### SUMMARY OF THE INVENTION

### Technical Problem

An objective of the present invention is to provide a curable silicone composition with excellent curability with UV radiation, and further with heating, to form a cured product with good transparency and mechanical properties. Another objective of the present invention is to provide a cured product with excellent adhesive/adhesion, transparency and mechanical properties.

### Solution to Problem

The curable silicone composition of the present invention comprises:

(A) an epoxy-functional silicone resin represented by the following average unit formula:

(R¹₃SiO_{1/2})ₐ(R¹₂SiO_{2/2})_{b}(R¹SiO_{3/2})_{c}(SiO_{4/2})_{d}

wherein each R¹ is the same or different organic group selected from a C₁₋₆ monovalent aliphatic hydrocarbon group, C₆₋₁₀ monovalent aromatic hydrocarbon group, and a monovalent epoxy-substituted organic group, provided that at least about 15 mol % of the total R¹ are the C₆₋₁₀ monovalent aromatic hydrocarbon groups; and “a”, “b”, “c” and “d” are numbers that satisfy the following conditions: 0≤a<0.4, 0<b<0.5, 0<c<1, 0≤d<0.4, 0.1≤b/c≤0.6, and a+b+c+d=1; and about 2 to about 30 mol % of the total siloxane units have the monovalent epoxy-substituted organic groups;
(B) an epoxy-functional silicone represented by the following general formula:

X¹—R²₂SiO(SiR²₂O)ₘSiR²₂—X¹

wherein each R² is the same or different organic group selected from a C₁₋₆ monovalent aliphatic hydrocarbon group and a C₆₋₁₀ monovalent aromatic hydrocarbon group, provided that at least about 10 mol % of the total R² are the C₆₋₁₀ monovalent aromatic hydrocarbon groups; each X¹ is the same or different group selected from a monovalent epoxy-substituted organic group and an epoxy-functional siloxy group represented by the following general formula:

X²—R³₂SiO(SiR³₂O)ₓSiR³₂—R⁴—

wherein each R³ is the same or different C₁₋₆ monovalent aliphatic hydrocarbon group; R⁴ is a C₂₋₆ alkylene group; X² is a monovalent epoxy-substituted organic group; and “x” is a number of from about 0 to about 5,
and “m” is a number of from about 5 to about 100, in an amount of from about 5 mass % to about 40 mass % of the total mass of components (A), (B) and (C); and
(C) a cationic photoinitiator, in an amount of from about 0.2 mass % to about 2 mass % of the total mass of components (A), (B) and (C).

In various embodiments, the monovalent epoxy-substituted organic groups in component (A) are groups selected from glycidoxyalkyl groups, 3,4-epoxycyclohexylalkyl groups, and epoxyalkyl groups.

In various embodiments, the monovalent epoxy-substituted organic groups in component (B) are groups selected from glycidoxyalkyl groups, 3,4-epoxycyclohexylalkyl groups, and epoxyalkyl groups.

In various embodiments, the curable silicone composition further comprises: (D) an epoxy-functional silicone represented by the following general formula:

X¹—R³₂SiO(SiR³₂O)ₙSiR³₂—X¹

wherein each R³ is the same or different C₁₋₆ monovalent aliphatic hydrocarbon group; each X¹ is the same or different group selected from a monovalent epoxy-substituted organic group and an epoxy-functional siloxy group represented by the following general formula:

X²—R³₂SiO(SiR³₂O)ₓSiR³₂—R⁴—

wherein each R³ is the same or different C₁₋₆ monovalent aliphatic hydrocarbon group; R⁴ is a C₂₋₆ alkylene group; X² is a monovalent epoxy-substituted organic group; and “x” is a number of from about 0 to about 5,
and “n” is a number of from about 0 to about 10, in an amount of from about 0.1 mass % to about 10 mass % of the total mass of components (A), (B), (C) and (D).

In various embodiments, the monovalent epoxy-substituted organic groups in component (D) are groups selected from glycidoxyalkyl groups, 3,4-epoxycyclohexylalkyl groups, and epoxyalkyl groups.

In various embodiments, the curable silicone composition further comprises: (E) an adhesion promoter, in an amount of from about 0.01 to about 5 mass % of the total mass of components (A), (B), (C) and (E).

In various embodiments, the curable silicone composition further comprises: (F) a photosensitizer, in an amount of from about 0.001 to about 0.1 mass % of the total mass of components (A), (B), (C) and (F).

In various embodiments, the curable silicone composition further comprises: (G) an alcohol, in an amount of from about 0.01 to about 10 mass % of the total mass of components (A), (B), (C) and (G).

In various embodiments, the curable silicone composition further comprises: (H) an inorganic filler, in an amount of from about 1 to about 95 mass % of the total mass of components (A), (B), (C) and (H).

The cured product of the present invention is obtained by curing the curable silicone composition described above.

### Effects of Invention

The curable silicone composition of the present invention has excellent curability with UV radiation, and further with heating to form a cured product with excellent transparency and mechanical properties. While, the cured product of the present invention has excellent adhesive/adhesion, transparency and mechanical properties.

### DETAILED DESCRIPTION OF THE INVENTION

The terms “comprising” or “comprise” are used herein in their broadest sense to mean and encompass the notions of “including,” “include,” “consist(ing) essentially of,” and “consist(ing) of. The use of “for example,” “e.g.,” “such as,” and “including” to list illustrative examples does not limit to only the listed examples. Thus, “for example” or “such as” means “for example, but not limited to” or “such as, but not limited to” and encompasses other similar or equivalent examples. The term “about” as used herein serves to reasonably encompass or describe minor variations in numerical values measured by instrumental analysis or as a result of sample handling. Such minor variations may be in the order of ±0-25, ±0-10, ±0-5, or ±0-2.5, % of the numerical values. Further, the term “about” applies to both numerical values when associated with a range of values. Moreover, the term “about” may apply to numerical values even when not explicitly stated.

Generally, as used herein a hyphen “-” or dash “—” in a range of values is “to” or “through”; a “>” is “above” or “greater-than”; a “≥” is “at least” or “greater-than or equal to”; a “<” is “below” or “less-than”; and a “≤” is “at most” or “less-than or equal to.” On an individual basis, each of the aforementioned applications for patent, patents, and/or patent application publications, is expressly incorporated herein by reference in its entirety in one or more non-limiting embodiments.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

It is also to be understood that any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The terms “epoxy-functional” or “epoxy-substituted” as used herein refers to a functional group in which an oxygen atom, the epoxy substituent, is directly attached to two adjacent carbon atoms of a carbon chain or ring system. Examples of epoxy-substituted functional groups include, but are not limited to, glycidoxyalkyl groups such as 2-glycidoxyethyl groups, 3-glycidoxypropyl groups, 4-glycidoxybutyl groups or the like; (3,4-epoxycycloalkyl)alkyl groups such as 2-(3,4-epoxycylohexyl)ethyl groups, 3-(3,4-epoxycylohexyl)propyl groups, 2-(3,4-epoxy-3-methylcylohexyl)-2-methylethyl groups, 2-(2,3-epoxycylopentyl)ethyl groups, 3-(2,3-epoxycylopentyl)propyl groups, and the like; and epoxyalkyl groups such as 2,3-epoxypropyl groups, 3,4-epoxybutyl groups, 4,5-epoxypentyl groups, and the like.

### Curable Silicone Composition

Component (A) is an epoxy-functional silicone resin represented by the following average siloxane unit formula:

(R¹₃SiO_{1/2})ₐ(R¹₂SiO_{2/2})_{b}(R¹SiO_{3/2})_{c}(SiO_{4/2})_{d}.

In the formula, each R¹ is the same or different organic group selected from a C₁₋₆ monovalent aliphatic hydrocarbon group, C₆₋₁₀ monovalent aromatic hydrocarbon group, and a monovalent epoxy-substituted organic group.

Examples of the C₁₋₆ monovalent aliphatic hydrocarbon groups in component (A) include C₁₋₆ alkyl groups such as methyl groups, ethyl groups, propyl groups, butyl group, and hexyl groups; C₂₋₆ alkenyl groups such as vinyl groups, allyl groups, and hexenyl groups; and C₁₋₆ halogenated alkyl groups such as 3-chloropropyl groups and 3,3,3-trifluoropropyl groups. Among these, methyl groups are generally preferred.

Examples of the C₆₋₁₀ monovalent aromatic hydrocarbon groups in component (A) include phenyl groups, tolyl groups, xylyl groups, and naphthyl groups. Among these, phenyl groups are generally preferred.

Examples of the monovalent epoxy-substituted organic groups in component (A) include glycidoxyalkyl groups such as 3-glycidoxypropyl groups, 4-glycidoxybutyl groups and 5-glycidoxypentyl groups; 3,4-epoxycycloalkyl alkyl groups such as 2-(3,4-epoxycylohexyl)ethyl, 3-(3,4-epoxycylohexyl)propyl, 2-(3,4-epoxy-3-methylcylohexyl)-2-methylethyl, 2-(2,3-epoxycylopentyl)ethyl, and 3-(2,3-epoxycylopentyl)propyl; and epoxyalkyl groups such as 2,3-epoxypropyl groups, 3,4-epoxybutyl groups, and 4,5-epoxypentyl groups. Among these, 3,4-epoxycycloalkyl alkyl groups are generally preferred.

In component (A), at least about 15 mol %, optionally at least about 20 mol %, or optionally at least about 25 mol %, of the total R¹ are the C₆₋₁₀ monovalent aromatic hydrocarbon groups. If the content of the monovalent aromatic hydrocarbon groups is greater than or equal to the lower limit described above, the optical transmittance of the cured product can increase as well as mechanical properties thereof increase.

In the formula, “a”, “b”, “c”, and “d” are mole fractions and numbers that satisfy the following conditions: 0≤a<0.4, 0<b<0.5, 0<c<1, 0≤d<0.4, 0.1≤b/c≤0.6, and a+b+c+d=1, optionally a=0, 0<b<0.5, 0<c<1, 0≤d<0.2, 0.1<b/c≤0.6, and b+c+d=1, or optionally a=0, 0<b<0.5, 0<c<1, d=0, 0.1<b/c≤0.6, and b+c=1. “a” is 0≤a<0.4, optionally 0≤a<0.2, or optionally a=0, because the molecular weight of the epoxy-containing organopolysiloxane resin (A) drops when there are too many (R¹₃SiO_{1/2}) siloxane units, and, when (SiO_{4/2}) siloxane units are introduced, the hardness of the cured product of the epoxy-functional silicone resin (A) is markedly increased and the product can be easily rendered brittle. For this reason, “d” is 0≤d<0.4, optionally 0≤d<0.2, or optionally d=0. In addition, the molar ratio “b/c” of the (R¹₂SiO_{2/2}) units and (R¹SiO_{3/2}) units can be not less than about 0.1 and not more than about 0.6. In some examples, deviation from this range in the manufacture of the epoxy-functional silicone resin (A) can result in generation of insoluble side products, in making the product more prone to cracking due to decreased toughness, or in a decrease in the strength and elasticity of the product and making it more prone to scratching. In some examples, the range molar ratio “b/c” is more than about 0.1 and not more than about 0.6. The epoxy-functional silicone resin (A) contains the (R¹₂SiO_{2/2}) siloxane units and the (R¹SiO_{3/2}) siloxane units, and its molecular structure is in most cases a network structure or a three-dimensional structure because the molar ratio of “b/c” is more than about 0.1 and not more than about 0.6. Thus, in the epoxy-functional silicone resin (A), the (R¹₂SiO_{2/2}) siloxane units and the (R¹SiO_{3/2}) siloxane units are present, whereas the (R¹₃SiO_{1/2}) siloxane units and the (SiO_{4/2}) siloxane units are optional constituent units. That is, there can be epoxy-functional silicone resins including the following average unit formulas:

(R¹₂SiO_{2/2})_{b}(R¹SiO_{3/2})_{c}

(R¹₃SiO_{1/2})ₐ(R¹₂SiO_{2/2})_{b}(R¹SiO_{3/2})_{c}

(R¹₂SiO_{2/2})_{b}(R¹SiO_{3/2})_{c}(SiO_{4/2})_{d}

(R¹₃SiO_{1/2})ₐ(R¹₂SiO_{2/2})_{b}(R¹SiO_{3/2})_{c}(SiO_{4/2})_{d}

In component (A), about 2 to about 30 mol % of siloxane units, optionally about 10 mol % to about 30 mol %, or optionally about 15 mol % to about 30 mol %, of all the siloxane units in a molecule have epoxy-substituted organic groups. If there is greater than or equal to the lower limit of the range mentioned above of such siloxane units, the density of cross-linking during curing can increase. On the other hand, the amount is less than or equal to the upper limit of the range mentioned above can be suitable because it can bring about an increase in the optical transmittance and heat resistance of the cured product. In the epoxy-functional monovalent hydrocarbon groups, the epoxy groups can be bonded to silicon atoms through alkylene groups, such that these epoxy groups are not directly bonded to the silicon atoms. The epoxy-functional silicone resin (A) can be produced by well-known conventional manufacturing methods.

While there are no particular limitations concerning the weight-average molecular weight of the epoxy-functional silicone resin (A), if the toughness of the cured product and its solubility in organic solvents are taken into consideration, in some embodiments the molecular weight is not less than about 10³ and not more than about 10⁶. In one embodiment, the epoxy-functional silicone resin (A) includes a combination of two or more kinds of such epoxy-functional silicone resins with different content and type of the epoxy-containing organic groups and monovalent hydrocarbon groups or with different molecular weights.

Component (B) is an epoxy-functional silicone represented by the following general formula:

X¹—R²₂SiO(SiR²₂O)ₘSiR²₂—X¹.

In the formula, each R² is the same or different organic group selected from a C₁₋₆ monovalent aliphatic hydrocarbon group and a C₆₋₁₀ monovalent aromatic hydrocarbon group.

Examples of the C₁₋₆ monovalent aliphatic hydrocarbon groups in component (B) include C₁₋₆ alkyl groups such as methyl groups, ethyl groups, propyl groups, butyl group, and hexyl groups; C₂₋₆ alkenyl groups such as vinyl groups, allyl groups, and hexenyl groups; and C₁₋₆ halogenated alkyl groups such as 3-chloropropyl groups and 3,3,3-trifluoropropyl groups. Among these, methyl groups are generally preferred.

Examples of the C₆₋₁₀ monovalent aromatic hydrocarbon groups in component (B) include phenyl groups, tolyl groups, xylyl groups, and naphthyl groups. Among these, phenyl groups are generally preferred.

In component (B), at least about 10 mol %, optionally at least about 20 mol %, optionally at least about 30 mol %, or optionally at least about 40 mol %, of the total R² are the C₆₋₁₀ monovalent aromatic hydrocarbon groups. If the content of the monovalent aromatic hydrocarbon groups is greater than or equal to the low limit described above, optical transmittance of the cured product can increase as well as mechanical properties of the cured product increase.

In the formula, each X¹ is the same or different group selected from a monovalent epoxy-substituted organic group and an epoxy-functional siloxy group represented by the following general formula:

X²—R³₂SiO(SiR³₂O)ₓSiR³₂—R⁴—.

Examples of the monovalent epoxy-substituted organic groups for X¹ include glycidoxyalkyl groups such as 3-glycidoxypropyl groups, 4-glycidoxybutyl groups and 5-glycidoxypentyl groups; 3,4-epoxycycloalkyl alkyl groups such as 2-(3,4-epoxycylohexyl)ethyl, 3-(3,4-epoxycylohexyl)propyl, 2-(3,4-epoxy-3-methylcylohexyl)-2-methylethyl, 2-(2,3-epoxycylopentyl)ethyl, and 3-(2,3-epoxycylopentyl)propyl; and epoxyalkyl groups such as 2,3-epoxypropyl groups, 3,4-epoxybutyl groups, and 4,5-epoxypentyl groups. Among these, 3,4-epoxycycloalkyl alkyl groups are generally preferred.

In the general formula above, each R³ is the same or different C₁₋₆ monovalent aliphatic hydrocarbon group. Examples of the C₁₋₆ monovalent aliphatic hydrocarbon groups for R³ include C₁₋₆ alkyl groups such as methyl groups, ethyl groups, propyl groups, butyl group, and hexyl groups; C₂₋₆ alkenyl groups such as vinyl groups, allyl groups, and hexenyl groups; and C₁₋₆ halogenated alkyl groups such as 3-chloropropyl groups and 3,3,3-trifluoropropyl groups. Among these, methyl groups are generally preferred.

In the general formula above, R⁴ is a C₂₋₆ alkylene group. Examples of the C₂₋₆ alkylene groups for R⁴ include ethylene groups, methylethylene groups, propylene groups, butylene group, and hexylene groups. Among these, ethylene groups are generally preferred.

In the general formula above, X² is a monovalent epoxy-substituted organic group. Examples of the monovalent epoxy-substituted organic groups for X² include glycidoxyalkyl groups such as 3-glycidoxypropyl groups, 4-glycidoxybutyl groups and 5-glycidoxypentyl groups; 3,4-epoxycycloalkyl alkyl groups such as 2-(3,4-epoxycylohexyl)ethyl, 3-(3,4-epoxycylohexyl)propyl, 2-(3,4-epoxy-3-methylcylohexyl)-2-methylethyl, 2-(2,3-epoxycylopentyl)ethyl, and 3-(2,3-epoxycylopentyl)propyl; and epoxyalkyl groups such as 2,3-epoxypropyl groups, 3,4-epoxybutyl groups, and 4,5-epoxypentyl groups. Among these, 3,4-epoxycycloalkyl alkyl groups are generally preferred.

In the general formula above, “x” is a number of from about 0 to about 5, optionally from about 0 to about 2, or optionally about 0.

In the general formula above, “m” is a number of from about 5 to about 100, optionally from about 5 to about 50, or optionally from about 10 to about 50. If “m” is greater than or equal to the lower limit of the range described above, the impact strength of the cured product can increase as well as reliability properties of the cured product increase.

The state of component (B) at 25° C. is not limited, but it is generally a liquid. The viscosity at 25° C. of component (B) is not limited; however, the viscosity is generally in a range of from about 100 to about 1,000,000 mPa·s. Note that in the present specification, viscosity is the value measured using a type B viscometer according to ASTM D 1084 at 23±2° C.

The content of component (B) is in an amount of from about 5 mass % to about 40 mass %, optionally in an amount of from about 10 mass % to about 40 mass %, optionally in an amount of from about 10 mass % to about 35 mass %, or optionally in an amount of from 10 mass % to about 30 mass %, of the total mass of components (A), (B) and (C). If the content of component (B) is greater than or equal to the lower limit of the range described above, flexibility and impact strength of the cured product can increase. On the other hand, the content is less than or equal to the upper limit of the range described above, toughness and tensile strength of the cured product can increase.

Component (C) is a cationic photoinitiator used as a photoinitiator for epoxy-functional silicone. Any cationic photoinitiator that is known by one of skill in the art can be used, such as sulfonium salts, iodonium salts, selenonium salts, phosphonium salts, diazonium salts, para-toluene sulfonates, trichloromethyl-substituted triazines, and trichloromethyl-substituted benzenes. Examples of sulfonium salts can include salts represented by the formula: R^{c}₃S⁺X⁻. In the formula, R^{c} can stand for methyl, ethyl, propyl, butyl, and other C₁₋₆ alkyl groups; phenyl, naphthyl, biphenyl, tolyl, propylphenyl, decylphenyl, dodecylphenyl, and other C₁₋₂₄ aryl group or substituted aryl groups, and X⁻ in the formula can represent SbF₆⁻, AsF₆⁻, PF₆⁻, BF₄⁻, B(C₆F₅)₄⁻, HSO₄⁻, ClO₄⁻, CF₃SO₃⁻ and other non-nucleophilic non-basic anions. Examples of iodonium salts can include salts represented by the formula: R^{c}₂I⁺X⁻; examples of selenonium salts can include salts represented by the formula: R^{c}₃Se⁺X⁻; examples of phosphonium salts can include salts represented by the formula: R^{c}₄P⁺X⁻; examples of diazonium salts can include salts represented by the formula: R^{c}N₂⁺X⁻; with the R^{c} and X⁻ in the formulas being the same as described herein for R^{c}₃S⁺X⁻. Examples of para-toluene sulfonates can include compounds represented by the formula: CH₃Cl₆H₄SO₃R^{c1}, with the R^{c1} in the formula standing for organic groups including electron-attracting groups, such as benzoylphenylmethyl groups, phthalimide groups, and the like. Examples of trichloromethyl-substituted triazines can include compounds represented by [CC1₃]₂C₃N₃R^{c2}, with the R^{c2} in the formula standing for phenyl, substituted or unsubstituted phenylethyl, substituted or unsubstituted furanylethynyl, and other electron-attracting groups. Examples of trichloromethyl-substituted benzenes can include compounds represented by CCl₃C₆H₃R^{c}R^{c3}, with the R^{c} in the formula being the same as described herein for R^{c}₃S⁺X⁻ and the R^{c3} standing for halogen groups, halogen-substituted alkyl groups, and other halogen-containing groups.

Examples of the photoinitiator can include, for example, triphenylsulfonium tetrafluoroborate, di(p-tertiary butylphenyl)iodonium hexafluoroantimonate, bis(dodecylphenyl)iodonium hexafluoroantimonate, 4-isopropyl-4′-methyldiphenyliodonium tetrakis(pentafluorophenyl)borate salt, and p-chlorophenyldiazonium tetrafluoroborate.

The content of component (C) is in an amount of from about 0.2 mass % to about 2 mass %, optionally in an amount of from about 0.2 mass % to about 1 mass %, or optionally in an amount of from about 0.2 mass % to about 0.8 mass %, of the total mass of components (A), (B) and (C). If the content of component (C) is greater than or equal to the lower limit of the range described above, the curable silicone composition is cured fully. On the other hand, the content is less than or equal to the upper limit of the range described above, optical performance of the cured product can increase.

The present composition comprises components (A) to (C) described above; however, to impart better mechanical strength to a cured product of the present composition, (D) an epoxy-functional silicone other than component (B), and/or (E) an adhesion promoter, and/or (F) a photosensitizer, and/or (G) an alcohol, and/or (H) an inorganic filler can be contained.

Component (D) is an epoxy-functional silicone represented by the following general formula:

X¹—R³₂SiO(SiR³₂O)ₙSiR³₂—X¹.

In the formula, each R³ is the same or different C₁₋₆ monovalent aliphatic hydrocarbon group. Examples of the C₁₋₆ monovalent aliphatic hydrocarbon groups for R³ include C₁₋₆ alkyl groups such as methyl groups, ethyl groups, propyl groups, butyl group, and hexyl groups; C₂₋₆ alkenyl groups such as vinyl groups, allyl groups, and hexenyl groups; and C₁₋₆ halogenated alkyl groups such as 3-chloropropyl groups and 3,3,3-trifluoropropyl groups. Among these, methyl groups are generally preferred.

In the formula, each X¹ is the same or different group selected from a monovalent epoxy-substituted organic group and an epoxy-functional siloxy group represented by the following general formula:

X²—R³₂SiO(SiR³₂O)ₓSiR³₂—R⁴—.

Examples of the monovalent epoxy-substituted organic groups for X¹ include glycidoxyalkyl groups such as 3-glycidoxypropyl groups, 4-glycidoxybutyl groups and 5-glycidoxypentyl groups; 3,4-epoxycycloalkyl alkyl groups such as 2-(3,4-epoxycylohexyl)ethyl, 3-(3,4-epoxycylohexyl)propyl, 2-(3,4-epoxy-3-methylcylohexyl)-2-methylethyl, 2-(2,3-epoxycylopentyl)ethyl, and 3-(2,3-epoxycylopentyl)propyl; and epoxyalkyl groups such as 2,3-epoxypropyl groups, 3,4-epoxybutyl groups, and 4,5-epoxypentyl groups. Among these, 3,4-epoxycycloalkyl alkyl groups are generally preferred.

In the general formula above, each R³ is the same or different C₁₋₆ monovalent aliphatic hydrocarbon group. Examples of the C₁₋₆ monovalent aliphatic hydrocarbon groups for R³ include C₁₋₆ alkyl groups such as methyl groups, ethyl groups, propyl groups, butyl group, and hexyl groups; C₂₋₆ alkenyl groups such as vinyl groups, allyl groups, and hexenyl groups; and C₁₋₆ halogenated alkyl groups such as 3-chloropropyl groups and 3,3,3-trifluoropropyl groups. Among these, methyl groups are generally preferred.

In the general formula above, R⁴ is a C₂₋₆ alkylene group. Examples of the C₂₋₆ alkylene groups for R⁴ include ethylene groups, methylethylene groups, propylene groups, butylene group, and hexylene groups. Among these, ethylene groups are generally preferred.

In the general formula above, X² is a monovalent epoxy-substituted organic group. Examples of the monovalent epoxy-substituted organic groups for X² include glycidoxyalkyl groups such as 3-glycidoxypropyl groups, 4-glycidoxybutyl groups and 5-glycidoxypentyl groups; 3,4-epoxycycloalkyl alkyl groups such as 2-(3,4-epoxycylohexyl)ethyl, 3-(3,4-epoxycylohexyl)propyl, 2-(3,4-epoxy-3-methylcylohexyl)-2-methylethyl, 2-(2,3-epoxycylopentyl)ethyl, and 3-(2,3-epoxycylopentyl)propyl; and epoxyalkyl groups such as 2,3-epoxypropyl groups, 3,4-epoxybutyl groups, and 4,5-epoxypentyl groups. Among these, 3,4-epoxycycloalkyl alkyl groups are generally preferred.

In the general formula above, “x” is a number of from about 0 to about 5, optionally from about 0 to about 2, or optionally about 0.

In the general formula above, “n” is a number of from about 0 to about 10, optionally from about 0 to about 20, or optionally from about 0 to about 10. If “n” is greater than or equal to the lower limit of the range described above, the elasticity and impact strength of the cured product can increase. On the other hand, it is less than or equal to the upper limit of the range described above, optical performance of the cured product can increase.

The state of component (D) at 25° C. is not limited, but it is generally a liquid. The viscosity at 25° C. of component (D) is not limited; however, the viscosity is generally in a range of from about 5 to about 100 mPa·s. Note that in the present specification, viscosity is the value measured using a type B viscometer according to ASTM D 1084 at 23±2° C.

The content of component (D) is not limited, but it is generally in an amount of from about 0.1 mass % to about 10 mass %, or optionally in an amount of from about 0.1 mass % to about 5 mass %, of the total mass of components (A), (B), (C) and (D). If the content of component (D) is greater than or equal to the lower limit of the range described above, modulus of the cured product can increase. On the other hand, it is less than or equal to the upper limit of the range described above, elasticity and impact strength of the cured product can increase.

Component (E) is an adhesion promoter. Examples of adhesion promoters include epoxy-functional alkoxysilane such as 3-glycidoxypropyltrimethoxysilane, 3-glycidoxypropyltriethoxysilane, 2-(3,4-epoxycyclohexyl)ethyldimethoxysilane, 2-(3,4-epoxycyclohexyl)ethyldiethoxysilane and combinations thereof; unsaturated alkoxysilanes such as vinyltrimethoxysilane, allyltrimethoxysilane, allyltriethoxysilane, hexenyltrimethoxysilane, undecylenyltrimethoxysilane, 3-methacryloyloxypropyl trimethoxysilane, 3-methacryloyloxypropyl triethoxysilane, 3-acryloyloxypropyl trimethoxysilane, 3-acryloyloxypropyl triethoxysilane, and combinations thereof; an epoxy-functional siloxane with silicon atom-bonded alkoxy groups such as a reaction product of a hydroxy-terminated polyorganosiloxane with an epoxy-functional alkoxysilane (e.g. such as one of those described above), or a physical blend of the hydroxy-terminated polyorganosiloxane with the epoxy-functional alkoxysilane. The adhesion promoter may comprise a combination of an epoxy-functional alkoxysilane and an epoxy-functional siloxane. For example, the adhesion promoter is exemplified by a mixture of 3-glycidoxypropyltrimethoxysilane and a reaction product of hydroxy-terminated methylvinylsiloxane with 3-glycidoxypropyltrimethoxysilane, or a mixture of 3-glycidoxypropyltrimethoxysilane and a hydroxy-terminated methylvinylsiloxane, or a mixture of 3-glycidoxypropyltrimethoxysilane and a hydroxy-terminated methylvinyl/dimethylsiloxane copolymer.

The content of component (E) is not limited, but it is generally in an amount of from about 0.01 to about 5 mass %, or optionally in an amount of from about 0.1 to about 2 mass %, of the total mass of components (A), (B), (C) and (E). If the content of component (E) is greater than or equal to the lower limit of the range described above, adhesion properties of the cured product can increase. On the other hand, it is less than or equal to the upper limit of the range described above, mechanical properties of the cured product can increase.

Component (F) is a photosensitizer. Examples of the photosensitizer for component (F) include isopropyl-9H-thioxanthen-9-one, anthrone, 1-hydroxycyclohexyl-phenylketone, 2,4-diethyl-9H-thioxanthen-9-one, 2-isopropyl thioxanthene, 2-hydroxy-2-methyl-1-phenylpropan-1-one, 2,6-bis(1,1-dimethylethyl)-4-methylphenol (BHT), pentaerythritol tetrakis[3-(3,5-di-tert-butyl-4-hydroxyphenyl)propionate], thiodiethylene bis[3-(3,5-di-tert-butyl-4-hydroxyphenyl)propionate], octadecyl-3-(3,5-di-tert-butyl-4-hydroxyphenyl)propionate, 2,4-dimethyl-6-(1-methylpentadecyl)phenol, diethyl[{3,5-bis(1,1-di-tert-butyl-4-hydroxyphenyl)methyl}phosphonate, 3 3′,3″,5,5′,5″-hexane-tert-butyl-4-a,a′,a″-(mesitylene-2,4,6-tolyl)tri-p-cresol, 4,6-bis(octylthiomethyl)-o-cresol, ethylenebis(oxyethylene)bis[3-(5-tert-butyl-4-hydroxy-m-tolyl)propionate], and hexamethylene bis[3-(3,5-di-tert-butyl-4-hydroxyphenyl)propionate].

The content of component (F) is not limited, but it is generally in a range of from about 0.001 to about 1 mass %, optionally in a range of from about 0.005 to about 0.5 mass %, or optionally in a range of from about 0.005 to about 0.1 mass %, of the total mass of components (A), (B), (C) and (F). If the content of component (F) is greater than or equal to the lower limit of the range described above, curability of the cured product can increase. On the other hand, it is less than or equal to the upper limit of the range described above, optical clearance of the cured product can increase.

Component (G) is an alcohol. Examples of the alcohol include monovalent alcohols such as ethyl alcohol, isopropyl alcohol, isobutyl alcohol, 1-decanol, 1-dodecanol, 1-octanol, oleyl alcohol, 1-hexadecanol, and stearyl alcohol; and multivalent alcohols such as ethylene glycol, diethylene glycol, propylene glycol, 1,10-decanediol, glycerol, and pentaerythritol.

The content of component (G) is not limited, but it is generally in an amount of from about 0.01 to about 10 mass %, or optionally in an amount of from about 0.1 to about 10 mass %, of the total mass of components (A), (B), (C) and (G). If the content of component (G) is greater than or equal to the lower limit of the range described above, curability of the curable silicone composition can increase. On the other hand, it is less than or equal to the upper limit of the range described above, mechanical properties of the cured product can increase.

Component (H) is an inorganic filler to enhance mechanical strength of a cure product. Examples of a filler for component (H) include one or more of finely divided treated or untreated precipitated or fumed silica; precipitated or ground calcium carbonate, zinc carbonate; clays such as finely divided kaolin; quartz powder; aluminum hydroxide; zirconium silicate; diatomaceous earth; wollastonite; pyrophylate; and metal oxides such as fumed or precipitated titanium dioxide, cerium oxide, magnesium oxide powder, zinc oxide, and iron oxide.

The content of component (H) is not limited, but it is generally in a range of from about 1 to about 95 mass %, optionally in a range of from about 5 to about 95 mass %, or optionally in a range of from about 5 to about 90 mass %, of the total mass of components (A), (B), (C) and (H). If the content of component (H) is greater than or equal to the lower limit of the range described above, electrical or thermal conductivity of the cured product can increase. On the other hand, it is less than or equal to the upper limit of the range described above, handleability of the curable silicone composition can increase.

The present composition can be cured by irradiation of UV ray (or ultraviolet (“UV”) light). For example, low pressure, high pressure or ultrahigh pressure mercury lamp, metal halide lamp, (pulse) xenon lamp, or an electrodeless lamp is useful as an UV lamp. Irradiation dose is generally in a range of from about 5 to about 6,000 mJ/cm², or optionally in a range of from about 10 to about 4,000 mJ/cm².

### Cured Product

The present composition forms a cured product when cured by irradiation with UV ray. This cured product according to the present invention has a hardness, as measured using Shore D hardness specified in ASTM D2240, in the range from at least 20 to not more than 95, typically in the range from at least 30 to not more than 80, and more typically in the range from at least 30 to not more than 70. The reasons for this are as follows: the cured product may have insufficient strength when its hardness is less than the lower limit for the cited range; when, on the other hand, the upper limit for the cited range is exceeded, the flexibility of the cured product under consideration tends to be inadequate.

In order to exhibit a satisfactory flexibility, this cured product may have an elongation as specified in ASTM D412 of at least 10%. The reason for this is that the flexibility of the cured product becomes unsatisfactory at below the indicated range.

The cured product of the present invention, because it is flexible and highly transparent, is useful as an optical member or component that is permeable to light, e.g., visible light, infrared, ultraviolet, far ultraviolet, x-ray, laser, and so forth. The cured product of the present invention is also useful as an optical member or component that must be flexible, e.g., due to use in a flexed or bent condition, and is also useful as an optical member or component for devices involved with high energy, high output light. In addition, an article or component having a flexible and highly transparent cured product layer can be made by making a composite in which the cured silicone material of the present invention is formed into a single article or body with any of various substrates, and an impact- and stress-relaxing function can also be expected from the cured product layer.

### EXAMPLES

The curable silicone composition and cured product of the present invention will now be described in detail using Practical and Comparative Examples. Note that, in the formulas, “Me”, “Pr”, “Vi”, “Ph”, “Gly” and “Ep” respectively indicates methyl group, propyl group, vinyl group, phenyl group. 3-glycidoxypropyl group and 2-(3,4-epoxycyclohexyl)ethyl group. The structure of the epoxy-functional silicone resins used in the examples was determined by conducting ¹³C NMR and ²⁹Si NMR measurements. The weight-average molecular weight of the epoxy-functional silicone resins was calculated using GPC based on comparison with polystyrene standards. Viscosity of epoxy-functional silicones and silicone resin was measured as follows.

### <Viscosity>

Viscosity at 23±2° C. was measured by using a type B viscometer (Brookfield HA or HB Type Rotational Viscometer with using Spindle #52 at 5 rpm) according to ASTM D 1084 “Standard Test Methods for Viscosity of Adhesive”.

### Practical Examples 1-7 and Comparative Examples 1-6

The following components were used to prepare curable silicone compositions (mass %) shown in Table 1.

The following epoxy-functional silicone resin was used as component (A).

(a1): an epoxy-functional silicone resin with a weight-average molecular weight of 2,000 to 6,000 and represented by the following average unit formula:

(MePhSiO_{2/2})_{0.34}(PrSiO_{3/2})_{0.50}(EpSiO_{3/2})_{0.16}

The following epoxy-functional silicone resin was used as comparison of component (A).

(a2): an epoxy-functional silicone resin with a weight-average molecular weight of 2,000 to 6,000 and represented by the following average unit formula:

(MePhSiO_{2/2})_{0.34}(PrSiO_{3/2})_{0.34}(EpSiO_{3/2})_{0.32}

The following epoxy-functional silicone was used as component (B).

(b1): an epoxy-functional silicone with a viscosity of 4,000 mPa·s, a weight-average molecular weight of 12,000, and represented by the following average formula:

Ep-SiMe₂OSiMe₂-C₂H₄—SiMe₂O(SiMePhO)₂₃SiMe₂-C₂H₄—SiMe₂OSiMe₂-Ep

The following epoxy-functional silicone was used as comparison of component (B).

(b2): an epoxy-functional silicone with a viscosity of 130 mPa·s, a weight-average molecular weight of 4,500, and represented by the following formula:

Ep-SiMe₂O(SiMe₂O)₁₄SiMe₂-Ep

The following cationic photoinitiators were used as component (C).

(c1): 4-isopropyl-4′-methyldiphenyliodonium tetrakis(pentafluorophenyl)borate salt (TR-PAG-3048 produced by Changzhou Tronly New Electronic Materials Co., Ltd.)
(c2): a triarylsulfonium borate salt (CPI-310B produced by San-Apro Ltd.)

The following epoxy-functional silicone was used as component (D).

(d1) an epoxy-functional silicone with a viscosity of 40 mPa·s, a weight-average molecular weight of 382, and represented by the following formula:

Ep-SiMe₂OSiMe₂-Ep

The following components were used as component (E).

(e1): a silicone resin with a viscosity of 4800 mPa·s, a weight-average molecular weight of 2,200 and represented by the following average unit formula:

(ViSiO_{3/2})_{0.21}(PhSiO_{3/2})_{0.31}(MeGlySiO_{2/2})_{0.48}

(e2): 3-glycidoxypropyl trimethoxysilane

The following components were used as component (F).

(f1): 2,4-diethyl-9H-thioxanthen-9-one
(f2): 2-isopropyl thioxanthene

The following component was used as component (G).

(g1): 1-decanol

The curable silicone compositions were evaluated as follows. The properties of the curable silicone compositions and cured products thereof are shown in Table 1.

### <Curability of Curable Silicone Composition>

About 0.1-3 g of curable silicone composition was loaded into a slide glass. After leveling the surface level by bar coater, it goes through Metal halide UV Lamps with H bulb in the light intensity of 5000 mW/cm². Curability of the curable silicone composition was evaluated as follows.

∘∘: cured rapidly (It can be cured even in lower light intensity.)

∘: cured

X: not cured

### <Adhesion Strength>

The adhesion strength of this material is determined by measuring the amount of pull required to separate a lap shear laminate (lap shear strength). The results are reported in kgf per square centimeter. The amount of adhesive or cohesive failure is estimated. The procedure is similar to ASTM D-816, ASTM D-1002, MIL-S-8802, ASTM C-961.

### <Hardness>

The indentation hardness of this material is measured using either the Shore “A” or Shore “D” durometer scale. The procedure is based on ASTM D 2240.

### <Elongation>

This method covers the determination of tensile strength, elongation, set and modulus of this materials. Samples are pulled at a constant rate to the point of rupture and the appropriate values calculated. This procedure is based on ASTM D 412. It is also similar to JIS Method K-6301, the primary difference being in the calculation mode.

### <Appearance of Cured Product>

After UV radiation, cured product was visually observed.

TABLE 1

| | | | Practical Examples | | | | | |
|---|---|---|---|---|---|---|---|---|
| | | | 1 | 2 | 3 | 4 | 5 | 6 |
| Curable silicone | (A) | (a1) | 76.21 | 75.45 | 75.45 | 76.21 | 76.21 | 76.21 |
| composition | | (a2) | 0 | 0 | 0 | 0 | 0 | 0 |
| (mass %) | (B) | (b1) | 19.05 | 18.86 | 18.86 | 19.05 | 19.05 | 19.05 |
| | | (b2) | 0 | 0 | 0 | 0 | 0 | 0 |
| | (C) | (c1) | 0.45 | 0.45 | 0.45 | 0 | 0.45 | 0.45 |
| | | (c2) | 0 | 0 | 0 | 0.45 | 0 | 0 |
| | (D) | (d1) | 4.29 | 4.24 | 4.24 | 4.29 | 4.29 | 4.29 |
| | (E) | (e1) | 0 | 0.99 | 0 | 0 | 0 | 0 |
| | | (e2) | 0 | 0 | 0.99 | 0 | 0 | 0 |
| | (F) | (f1) | 0 | 0 | 0 | 0 | 0.04 | 0 |
| | | (f2) | 0 | 0 | 0 | 0 | 0 | 0.04 |
| | (G) | (g1) | 0 | 0 | 0 | 0 | 0 | 0 |

| Curability | | ∘ | ∘ | ∘ | ∘ | ∘∘ | ∘∘ |
|---|---|---|---|---|---|---|---|
| Adhesion | Glass | 20 | 27 | 22 | 20 | 22 | 22 |
| Strength | Aluminum | 34 | — | — | — | — | — |
| (kgf/cm²) | | | | | | | |
| Hardness | UV Cure | 55 | 57 | 53 | 55 | 57 | 57 |
| | UV Cure + | 63 | — | — | — | — | — |
| | Heat Cure | | | | | | |

| | | | | | | |
|---|---|---|---|---|---|---|
| Elongation (%) | 14 | 12 | 14 | — | — | — |
| Appearance | Clear | Clear | Clear | Clear | Clear | Clear |
| Other Properties | Flexible | Flexible | Flexible | Flexible | Flexible | Flexible |

| | | | Practical | | | | | | |
|---|---|---|---|---|---|---|---|---|---|
| | | | Example | Comparative Examples | | | | | |
| | | | 7 | 1 | 2 | 3 | 4 | 5 | 6 |
| Curable silicone | (A) | (a1) | 71.22 | 0 | 76.21 | 99.50 | 0 | 76.21 | 76.19 |
| composition | | (a2) | 0 | 0 | 0 | 0 | 76.21 | 0 | 0 |
| (mass %) | (B) | (b1) | 17.81 | 99.50 | 0 | 0 | 19.05 | 19.05 | 0 |
| | | (b2) | 0 | 0 | 19.05 | 0 | 0 | 0 | 0 |
| | (C) | (c1) | 0.42 | 0.48 | 0.45 | 0.48 | 0.45 | 0.10 | 0.48 |
| | | (c2) | 0 | 0 | 0 | 0 | 0 | 0 | 0 |
| | (D) | (d1) | 4.01 | 0 | 4.29 | 0 | 4.29 | 4.29 | 23.33 |
| | (E) | (e1) | 0 | 0 | 0 | 0 | 0 | 0 | 0 |
| | | (e2) | 0 | 0 | 0 | 0 | 0 | 0 | 0 |
| | (F) | (f1) | 0 | 0 | 0 | 0 | 0 | 0 | 0 |
| | | (f2) | 0 | 0 | 0 | 0 | 0 | 0 | 0 |
| | (G) | (g1) | 6.54 | 0 | 0 | 0 | 0 | 0 | 0 |

| Curability | | ∘ | ∘ | ∘ | X | ∘ | X | ∘ |
|---|---|---|---|---|---|---|---|---|
| Adhesion | Glass | 12 | <5 | 15 | — | <5 | — | 8 |
| Strength | Aluminum | — | <5 | 18 | — | <5 | — | 10 |
| (kgf/cm²) | | | | | | | | |
| Hardness | UV Cure | 30 | 32 | 50 | — | 70 | — | 70 |
| | UV Cure + | — | — | 57 | — | 75 | — | 75 |
| | Heat Cure | | | | | | | |

| | | | | | | | |
|---|---|---|---|---|---|---|---|
| Elongation (%) | 20 | — | — | — | — | — | 1.5 |
| Appearance | Clear | Clear | Hazy | — | Hazy | — | Clear |
| Other Properties | Flexible | Too Low | Flexible | — | Too | — | Too |
| | | Modulus | | | Brittle | | Brittle |

### Practical Examples 8 and 9

The above components and the following components were used to prepare curable silicone compositions (mass %) shown in Table 2.

The following components were used as component (H).

(h1): spherical aluminum oxide powder with an average particle size of 5 μm
(h2): spherical silver-coated copper powder with an average particle size of 7.5 to 9.0 μm.

The curable silicone compositions were evaluated as follows. The properties of the curable silicone compositions and cured products thereof are shown in Table 1.

The cured sample were prepared, and thermal conductivity was measured based on ASTM D5470, steady state method.

The cured sample were prepared, and electrical conductivity was calculated from volume resistivity, measured by ASTM D257, IEC 62631-3-1.

TABLE 2

| | | | Practical Examples | |
|---|---|---|---|---|
| | | | 8 | 9 |
| Curable silicone | (A) | (a1) | 10.08 | 10.88 |
| composition | (B) | (b1) | 2.52 | 2.72 |
| (mass %) | (C) | (c1) | 0.42 | 0.42 |
| | (E) | (e1) | 1.00 | 1.00 |
| | (F) | (f2) | 0.01 | 0.01 |
| | (H) | (h1) | 86.00 | 0 |
| | | (h2) | 0 | 85.00 |

| Curability | | ∘ | ∘ |
|---|---|---|---|
| Adhesion Strength | Glass | 15 | 14 |
| (kgf/cm²) | Aluminum | 21 | 20 |
| Hardness | UV Cure | — | — |
| | UV Cure + Heat Cure | — | — |

| | | |
|---|---|---|
| Elongation (%) | — | — |
| Appearance | White | Gray |
| Thermal Conductivity (W/m · K) | 2.6 | — |
| Electrical Conductivity (Ω · cm) | — | 1.9 × 10⁻⁴ |

### INDUSTRIAL APPLICABILITY

The curable silicone composition of the present invention can be cured by irradiation with UV ray. Therefore, the present composition is useful as various adhesives, encapsulants, coating agents, and the like of electric/electronic parts.

1. A curable silicone composition comprising:
(A) an epoxy-functional silicone resin represented by the following average unit formula:
(R¹₃SiO_{1/2})ₐ(R¹₂SiO_{2/2})_{b}(R¹SiO_{3/2})_{c}(SiO_{4/2})_{d}
wherein each R¹ is the same or different organic group selected from a C₁₋₆ monovalent aliphatic hydrocarbon group, C₆₋₁₀ monovalent aromatic hydrocarbon group, and a monovalent epoxy-substituted organic group, provided that at least about 15 mol % of the total R¹ are the C₆₋₁₀ monovalent aromatic hydrocarbon groups; and “a”, “b”, “c” and “d” are numbers that satisfy the following conditions: 0≤a<0.4, 0<b<0.5, 0<c<1, 0≤d<0.4, 0.1≤b/c≤0.6, and a+b+c+d=1; and about 2 to about 30 mol % of the total siloxane units have the monovalent epoxy-substituted organic groups;
(B) an epoxy-functional silicone represented by the following general formula:
X¹—R²₂SiO(SiR²₂O)ₘSiR²₂—X¹
wherein each R² is the same or different organic group selected from a C₁₋₆ monovalent aliphatic hydrocarbon group and a C₆₋₁₀ monovalent aromatic hydrocarbon group, provided that at least about 10 mol % of the total R² are the C₆₋₁₀ monovalent aromatic hydrocarbon groups; each X¹ is the same or different group selected from a monovalent epoxy-substituted organic group and an epoxy-functional siloxy group represented by the following general formula:
X²—R³₂SiO(SiR³₂O)ₓSiR³₂—R⁴—
wherein each R³ is the same or different C₁₋₆ monovalent aliphatic hydrocarbon group; R⁴ is a C₂₋₆ alkylene group; X² is a monovalent epoxy-substituted organic group;
and “x” is a number of from about 0 to about 5,
and “m” is a number of from about 5 to about 100, in an amount of from about 5 mass % to about 40 mass % of the total mass of components (A), (B) and (C); and
(C) a cationic photoinitiator, in an amount of from about 0.2 mass % to about 2 mass % of the total mass of components (A), (B) and (C).

2. The curable silicone composition according to claim 1, wherein the monovalent epoxy-substituted organic groups in component (A) are groups selected from glycidoxyalkyl groups, 3,4-epoxycyclohexylalkyl groups, and epoxyalkyl groups.

3. The curable silicone composition according to claim 1, wherein the monovalent epoxy-substituted organic groups in component (B) are groups selected from glycidoxyalkyl groups, 3,4-epoxycyclohexylalkyl groups, and epoxyalkyl groups.

4. The curable silicone composition according to claim 1, further comprising:
(D) an epoxy-functional silicone represented by the following general formula:
X¹—R³₂SiO(SiR³₂O)ₙSiR³₂—X¹
wherein each R³ is the same or different C₁₋₆ monovalent aliphatic hydrocarbon group; each X¹ is the same or different group selected from a monovalent epoxy-substituted organic group and an epoxy-functional siloxy group represented by the following general formula:
X²—R³₂SiO(SiR³₂O)ₓSiR³₂—R⁴—
wherein each R³ is the same or different C₁₋₆ monovalent aliphatic hydrocarbon group; R⁴ is a C₂₋₆ alkylene group; X² is a monovalent epoxy-substituted organic group;
and “x” is a number of from about 0 to about 5,
and “n” is a number of from about 0 to about 10, in an amount of from 0.1 mass % to about 10 mass % of the total mass of components (A), (B), (C) and (D).

5. The curable silicone composition according to claim 4, wherein the monovalent epoxy-substituted organic groups in component (D) are groups selected from glycidoxyalkyl groups, 3,4-epoxycyclohexylalkyl groups, and epoxyalkyl groups.

6. The curable silicone composition according to claim 1, further comprising:
(E) an adhesion promoter, in an amount of from about 0.01 to about 5 mass % of the total mass of components (A), (B), (C) and (E).

7. The curable silicone composition according to claim 1, further comprising:
(F) a photosensitizer, in an amount of from about 0.001 to about 0.1 mass % of the total mass of components (A), (B), (C) and (F).

8. The curable silicone composition according to claim 1, further comprising:
(G) an alcohol, in an amount of from about 0.01 to about 10 mass % of the total mass of components (A), (B), (C) and (G).

9. The curable silicone composition according to claim 1, further comprising:
(H) an inorganic filler, in an amount of from about 1 to about 95 mass % of the total mass of components (A), (B), (C) and (H).

10. A cured product obtained by curing the curable silicone composition according to claim 1.
